(19) United States
(12) Patent Application Publication
(10) Pub. No.: US 2003/0179757 A1
(43) Pub. Date: Sep. 25, 2003

(54) TRANSMISSION SYSTEM FOR TRANSMITTING A MULTIMEDIA SIGNAL

(76) Inventors: WARNER R. T. TEN KATE, EINDHOVEN (NL); RAKESH TAORI, EINDHOVEN (NL)

Correspondence Address: PHILIPS INTELLECTUAL PROPERTY & STANDARDS, P.O. BOX 3001, BRIARCLIFF MANOR, NY, 10510, US

(21) Appl. No.: 09/478,080

(22) Filed: Jan. 5, 2000

(30) Foreign Application Priority Data
Jan. 6, 1999 (EP) 99200027.3

(51) Int. Cl. H04L 12/28; H04L 12/56

(52) U.S. Cl. 370/395.61; 370/395.64

(57) ABSTRACT

In a communication system a multimedia signal is encoded in an encoder (1) and subsequently transmitted over a packet switched network (4) to a terminal (6). The terminal (6) comprises a receiver (8) whose output is connected to a receive buffer (210). The output of the receive buffer (210) is applied to the presentation means (214) which comprises a decoder (216) and a presentation device (218).

In order to deal with delay variations in the packet switched network (4), it is proposed to change the presentation speed of the multimedia signal dependent on the transmission delay of the multimedia signal. This is done by a controller (212) that determines the number of packets in the buffer (210) and adapts the decoding rate and the playback rate of the multimedia signal accordingly.

The present invention relates to an arrangement for reproducing a multimedia signal comprises presenting means for presenting the multimedia signal to a user. The present invention also relates to a method for reproducing a multimedia signal.

Such a system is known from the article “Reliable Audio for Use over the Internet” by V. Hardman et al published on the ISOC web site at URL: http:www.isoc.org/HMP/PAPER/2070/html/paper.html, May 4, 1995.

Systems as described in the above article are used for transmitting multimedia signals such as audio and video information over a packet switched network, such as e.g. the Internet, an ATM network or an MPEG-2 transport stream.

The major problems involved with real time transmission of multimedia signals over packet switched networks is the occurrence of packet loss, packet delay and packet delay spread. Packet loss is combated by using reconstruction techniques for completing the incomplete sequence of packets before they are presented to a user.

Packet delay spread is dealt with by using large receive buffers to have always packets available to be presented to a user. To make this possible, receive buffers have to be made large enough to deal with the maximum delay spread which can occur. This results in a substantial delay of the multimedia signal before it is presented to a user.

The large delay of the multimedia signal is in particular a problem in full duplex communication systems such as Internet telephony systems and multi-party systems such as video conferencing systems and networked games.

The object of the present invention is to provide a transmission system according to the preamble in which the total end-to-end delay has been substantially reduced.

To achieve said objective, the transmission system according to the inventions is characterized in that the second station comprises delay determining means for determining the arrival delay of packets carrying the multimedia signal, and in that the presenting means are arranged for changing the presenting speed in dependence on said arrival delay of packets carrying the multimedia signal.

By determining the packet delay and making the presentation speed dependent on said packed delay, buffers having smaller sizes can be used in the second station to deal with the delay spread. Due to the smaller buffer sizes in the second station, the total end to end delay is substantially reduced.

Experiments have shown that a variation of the presentation speed with about 240% is almost unnoticed by the user.

It is observed that the article “A New Technique for Audio Packet Loss Concealment” by H. Sanneck et al presented at the IEEE Globecom 219296 conference, London, November 218-222, 219296 and published in the Global Internet ′296 Conference Record, pp. 248-252, presents a method for reconstructing lost packets by time stretching of the original signal. It is observed however that the above article does not mention the use of time stretching as tool to reduce the end to end delay of a communication system for transmitting multimedia signals.

It is observed that the present inventive idea is not only applicable to transmission of multimedia signals over networks introducing jitter in to the multimedia signal, but that it is applicable in all situations where the availability of the multimedia shown some jitter.

A first example of this is when the content of the multimedia signal has to be computed on a programmable processor. The computing time will be dependent on the actual content of the multimedia, and consequently the multimedia signal will not be always available at exact regular instants. This is e.g. the case on computers running multitasking operating systems and when the computing of the multimedia signal involves rendering of detailed 3D images which is the case in all state of the art computer games. A second example is the retrieval of the multimedia signal from a storage device such as a CD-ROM or a hard disk.

Dependent on the actual position of the read head, the access time can vary, causing the introduction of jitter in the multimedia signal.

If the presentation speed is made dependent on the availability of the multimedia signal, a more smooth presentation of the multimedia signal can be the case.

An embodiment of the invention is characterized in that the multimedia signal comprises an audio signal, and in that the presenting means are arranged for changing the presenting speed of the audio signal without substantially changing a perceived intonation of the audio signal.

Changing the presentation speed without changing the intonation of the audio signal reduces the audibility of the changed presentation speed. Several ways of changing the presentation speed of an audio signal without changing the intonation of the audio signal are known from the prior art. An example of this is presented in the above-mentioned Globecom article.

A preferred embodiment of the communication system according to the invention is characterized in that the audio signal is represented by a plurality of segments comprising a plurality of signals being described by at least their amplitude and frequency, and in that the presenting means are arranged for changing the duration of said segments in dependence on said availability of packets.

The use of this representation of the audio signal enables a very easy change of the presentation speed, without changing the intonation of the audio signal. In this presentation, the fundamental frequency of the audio signal is defined by the property of the signals used to represent the signal, and the length of the segments used when reconstructing the audio signal defines the presentation speed.

When the length of the segments used in the reconstruction arrangement is larger than the nominal length of the segments, the play back presentation speed is lower than the original presentation speed.

When the length of the segments used in the reconstruction arrangement is smaller than the nominal length of the segments, the play back presentation speed is higher than the original presentation speed.

A further embodiment of the present invention is characterized in that the presentation means comprise control means having comparison means for determining a difference signal representing a difference between the delay measure and a reference value, and in that the presentation means comprises adjusting means for adjusting the presenting speed in dependence on the difference value.

This embodiment provides an easy and effective way for determining the presentation speed from the delay measure.

A further embodiment of the invention is characterized in that the presentation means comprises adaptation means for adapting the reference value in dependence on the variations of the difference value.

By changing the reference value in dependence on the variations of the difference value, the average buffer size can be made dependent on the actual amount of jitter present in the multimedia signal. If the jitter is high, the reference value will have a high value, resulting in a large number of packets that is present in the buffer. If the jitter is low, the reference value will have a low value, resulting in a small number of packets that is present in the buffer.

In this way the actual size of the buffer is never larger than is needed to deal with the actual amount of jitter present in the multimedia signal.

A further embodiment of the invention is useful when the multimedia signal comprises a video signal and is characterized in that the video signal is represented by a at least one object, and in that the presentation means are arranged for varying the presentation speed by adjusting a movement speed of at least one object in the video signal.

This embodiment of the invention is useful for video signal which id represented by a number of separate objects, as is the case in an MPEG-4 video signal. In such a video signal, the presentation speed can be easily varied by adjusting the movement speed of on or more objects. This way of changing the presentation speed is almost unnoticeable by a user of the device.

A further embodiment of the invention is characterized in that the multimedia signal comprises at least two components, in that the delay measure represents a timing difference between said at least two components, and in that the presentation means are arranged for varying the presentation speed in order to reduce said timing difference.

The present invention is also suitable to synchronize two or more components of a multimedia signal. The delay measure then represents a timing difference between the two components. This timing difference can e.g. be derived from time stamps included with each of the components of the multimedia signal.

The present invention will now be explained with reference to the drawings.

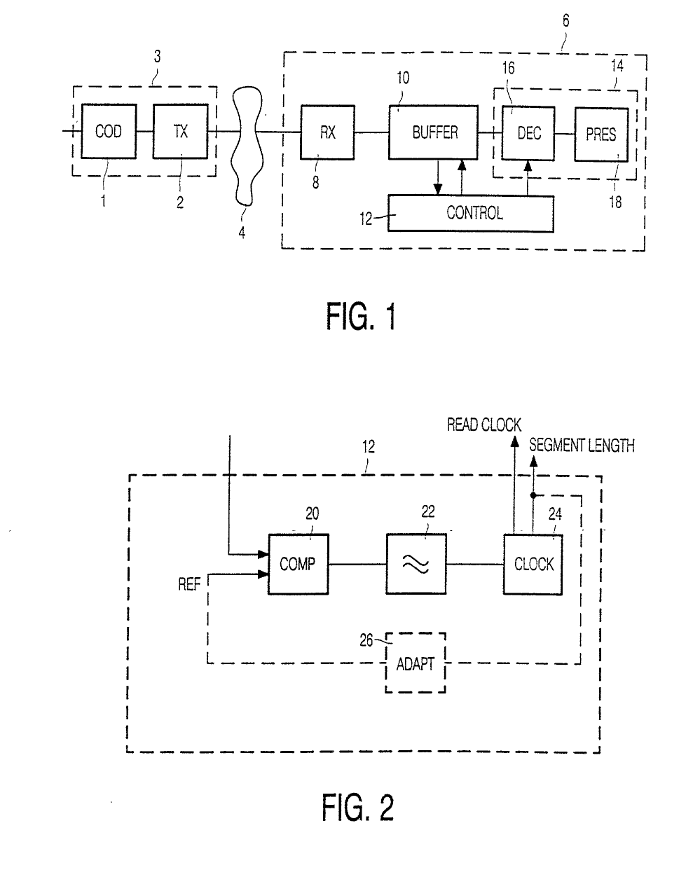

FIG. 1 shows a block diagram of a communication system according to the invention.

FIG. 2 shows the controller 212 to be used in the communication system according to FIG. 1.

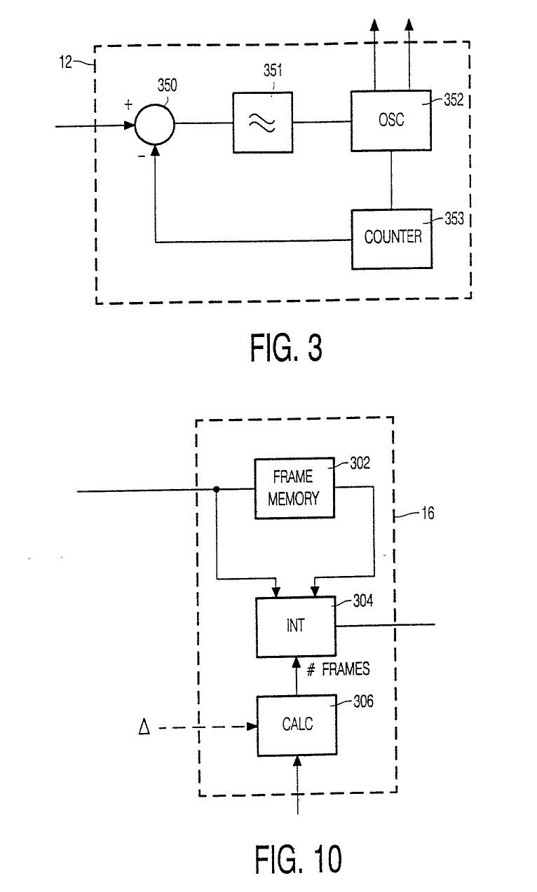

FIG. 3 shows al alternative embodiment of the controller 12 to be used in the system according to FIG. 1.

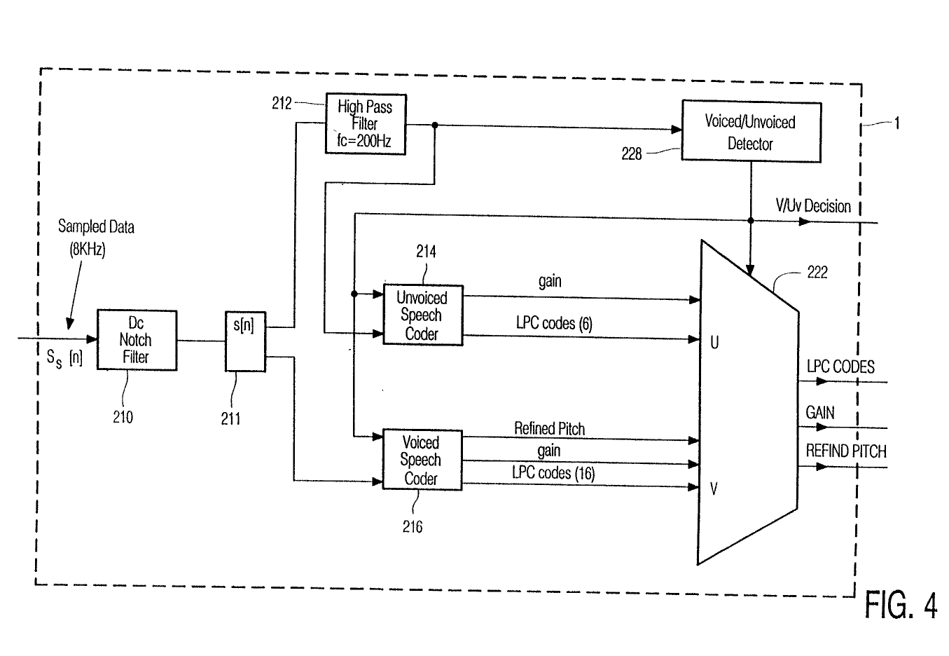

FIG. 4 shows a block diagram of an encoder 1 to be used in the communication system according to FIG. 1.

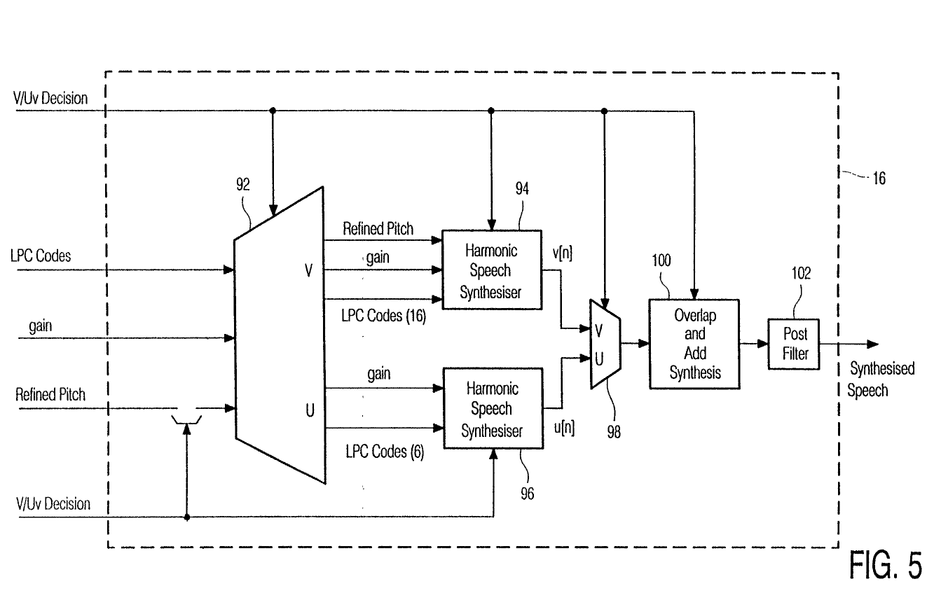

FIG. 5 shows a block diagram of a decoder 216 to be used in the communication system according to FIG. 1.

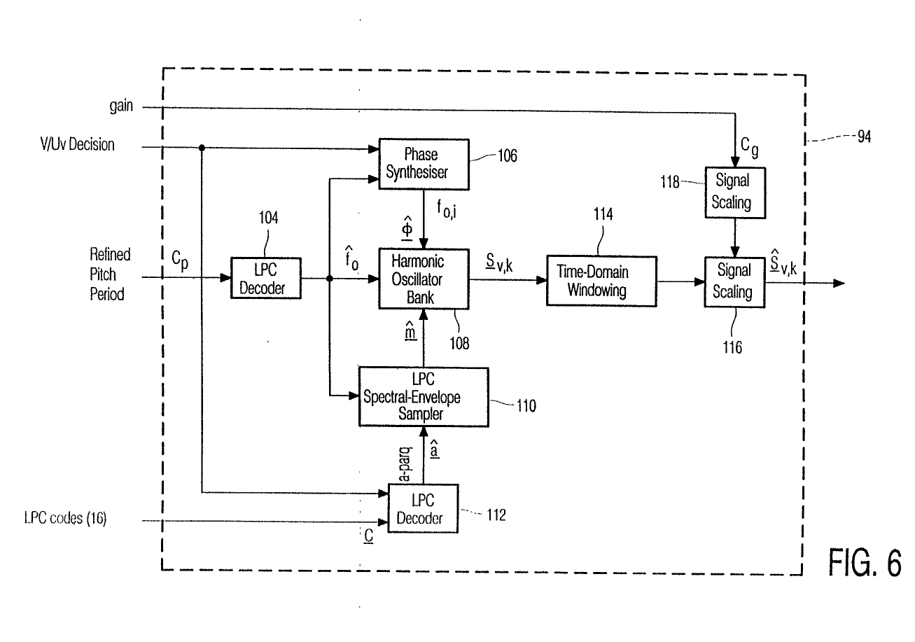

FIG. 6 shows the harmonic speech synthesizer 294 used in the decoder 216 in more detail.

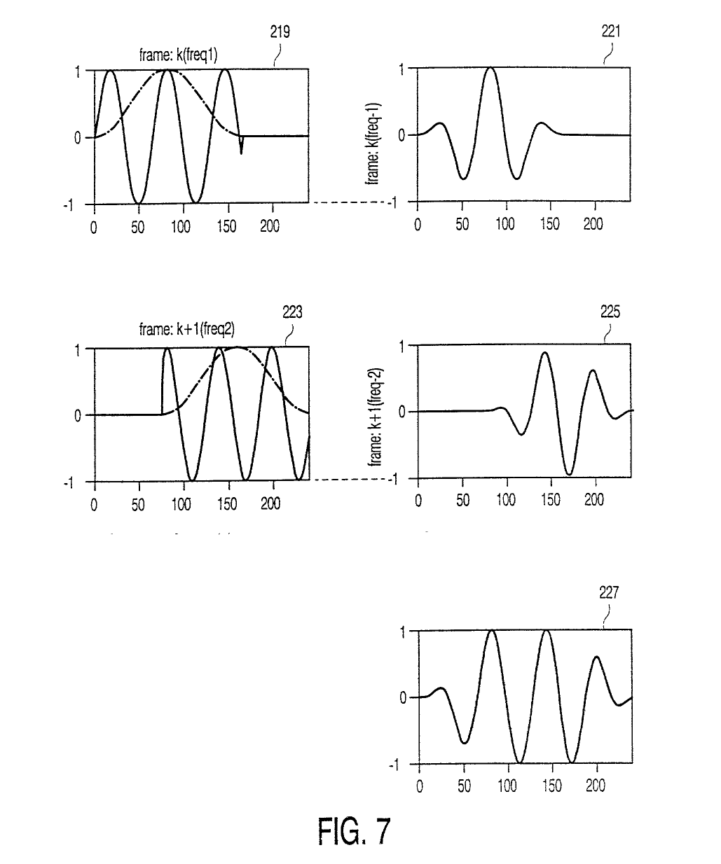

FIG. 7 shows different waveforms in the harmonic speech synthesizer 294 when the synthesis frame length is constant.

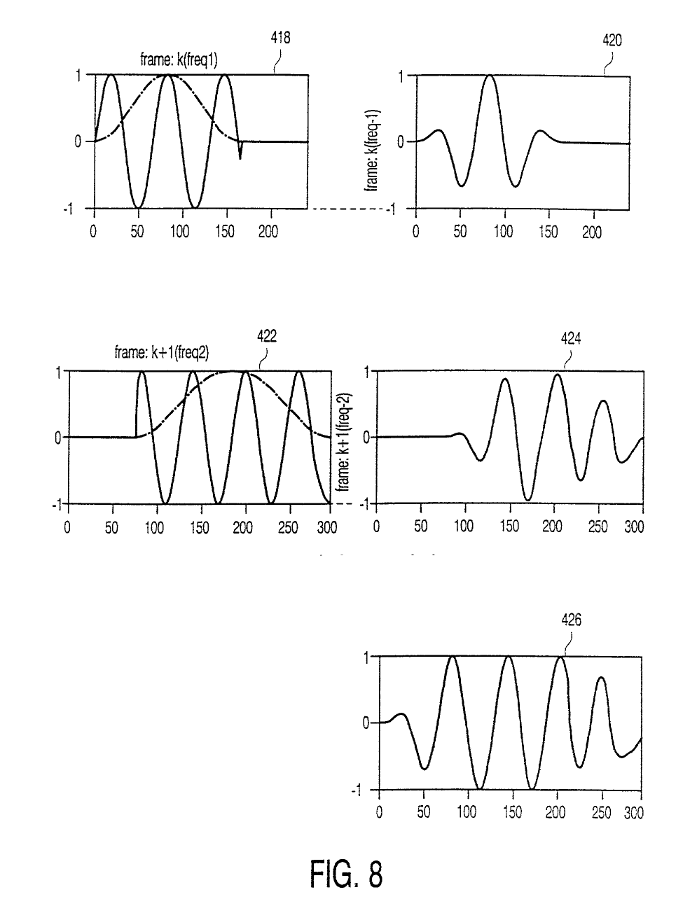

FIG. 8 shows different waveforms in the harmonic speech synthesizer 294 when the synthesis frame length changes between two adjacent synthesis frames.

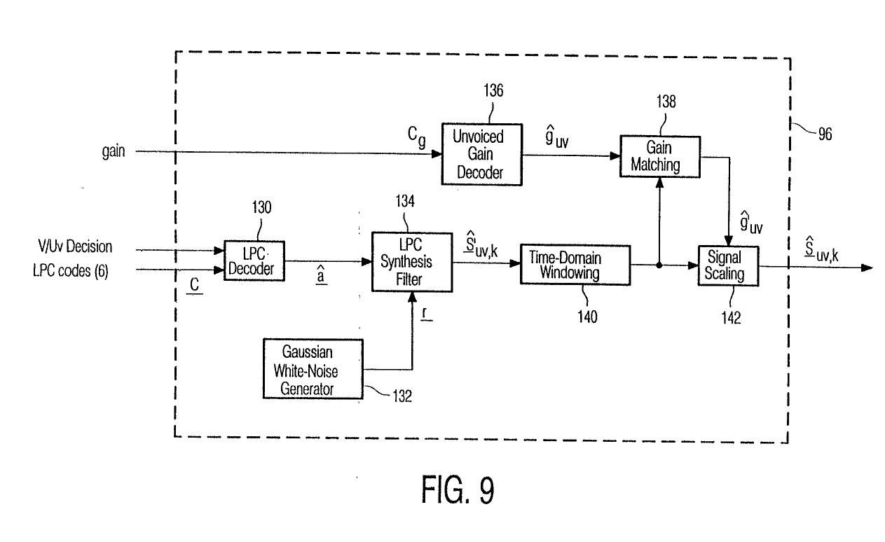

FIG. 9 shows the unvoiced speech synthesizer 296 used in the decoder 216 in more detail.

FIG. 10 shows a block diagram of a decoder 216 to be used in the system according to FIG. 1 for decoding a video signal.

In the communication system according to FIG. 1, a multimedia signal to be transmitted is applied to an encoder 1 in a first station 3. The encoder 1 is arranged for deriving an encoded multimedia signal from the input signal. The output of the encoder 1 is connected to an input of a transmitter 2. The transmitter 2 is arranged for deriving a transmit signal that is suitable for transmission. The output of the transmitter constitutes the output of the first station, and is connected to a packet switched transmission network 4.

Also a second station 6 is connected to the packet switched network 4. The second station 6 comprises a receiver 8 for receiving packets comprising the encoded multimedia signal from the network 4. The receiver 4 passes the packets comprising the multimedia signal to a buffer memory 10. The buffer memory 10 will be, in general, a FIFO memory in which the packets are read from the buffer memory 10 in the same order as they were written in the buffer memory 10. A first output of the buffer memory 10, carrying the buffered packets stored temporarily in the buffer memory 10, is connected to the presentation means 14.

A second output of the buffer memory 10, carrying the measure representing the arrival delay of packets carrying the multimedia signal, is connected to a first input of a control device 12. The measure representing the arrival delay can comprise the number of packets presently in the buffer. If the delay increases, the number of packets present in the buffer 10 will decrease, and when the delay decreases, the number of packets in the buffer will increase. The number of packets present in the buffer can easily be determined by calculating the difference between the positions of a read pointer and a write pointer.

If the multimedia signal comprises time stamps, it is also possible to derive the delay measure from a comparison of the timestamp associated with a predetermined part of the multimedia signal with the actual arrival time of said predetermined part of the multimedia signal.

A first output of the control device 12, carrying a read control signal, is connected to a second input of the buffer memory 10. The read control signal instructs the buffer memory 10 to present the next packet to its output. A second output of the control device 12, carrying a signal representing the presentation speed, is connected to a control input of a decoder 16 in the presentation means 14. According to the inventive concept of the present invention the control device 12 determines the presentation speed in dependence on a measure representing the transmission delay. This measure for the transmission delay is here the number of packets present in the buffer 10. The segment length indicator informs the decoder 16 about the actual length of the segment to be synthesized.

The decoder 16 derives segments of samples of the multimedia signal from the encoded signal received from the buffer 10. The duration of a segment need not to be constant, but may change in response to the segment length indicator in order to change the presentation speed of the multimedia signal. The output of the decoder 16 is connected to a presentation device 18, which can be a loudspeaker in case the multimedia signal comprises an audio signal and which can be a display device when the multimedia signal comprises a video signal.

In the control device 12 according to FIG. 2, an input signal representing the transmission delay is applied to a first input of a comparator 20. In the present embodiment, this input signal represents the number of packets in the buffer. The comparator 20 compares the number of packets in the buffer with a reference value REF. The output of the comparator 20 is coupled via a low pass filter 22 to a control input of a clock signal generator 24. The clock signal generator 24 generates the read control signal for the buffer 10 and the frame length indicator for the decoder 16.

If the number of packets in the buffer is smaller than the reference value, it means that the transmission delay has increased. Consequently the comparator 20 generates an output signal causing the clock signal generator to reduce the frequency of the read control signal and to increase the frame length indicated by the frame length indicator. This will result in a decreased presentation speed. Due to this decreased presentation speed, the buffer is read less often giving it a chance to fill with packets. Consequently, the number of packets in the buffer will increase after some time.

If the number of packets in the buffer exceeds the reference value REF, the output signal of the comparator will generate an output signal causing the clock signal generator to increase the frequency of the read control signal and to decrease the frame length indicated by the frame length indicator. The exceeding of the reference value can e.g. be caused by a suddenly decreased transmission delay. The increased frequency of the read control signal will result in an increased presentation speed. Due to this increased presentation speed, the number of packets in the buffer will decrease after some time.

In this way a control loop is obtained which compensates delay variations by changing the presentation speed accordingly. The filter 22 is present between the comparator 20 and the clock signal generator to obtain some smoothing of the output signal of the comparator before it is applied to the clock signal generator. It is also conceivable that the filter 22 is dispensed with.

In order to achieve the compensation of the delay variations with a minimum delay in the buffer 10, the reference value REF can be changed as a function of the (averaged) delay spread.

If the presentation speed is almost constant due to a transmission channel showing almost no delay spread, the size of the buffer can be very small. In this case, the reference value can be set to a low value.

If the presentation speed shows large variations due to a transmission channel showing a substantial delay spread, the size of the buffer should be larger to prevent that the buffer becomes empty. In this case, the reference value REF should be set to a substantially higher value.

By making the value REF dependent on the variations in the presentation speed, a buffer size is used which corresponds to the delay spread. These measures result in a low end-to-end delay without perceivable hiccups in the multimedia signal.

The delay spread can easily be determined by calculating the difference between a maximum value and a minimum value of the delay measure. This maximum and minimum delay values are determined over a given measuring time.

It is also possible to set the reference value at a low value at the start of the playback of a multimedia signal in order to obtain a fast response. In this way it is possible to reduce the response time to the duration of a few tens of packets, which corresponds to ±200 ms.

In the alternative embodiment of the controller 12 according to FIG. 3, it is assumed that each packet comprises a time stamp. By means of a counter 353 an artificial timestamp is derived from a clock signal generated by a clock oscillator 353 which also determines the presentation speed. An adder 350 determines the difference between the actual time stamp in the packet and the artificial time stamp available at the output of the counter 353. This difference is the delay measure according to the inventive concept of the present invention.

If the actual time stamp is larger than the artificial time stamp, the presentation speed is lower that the speed with which new packets arrive. In order to prevent overflow of the buffer, the presentation speed is increased. If the actual time stamp is smaller than the artificial time stamp, the presentation speed is higher than the speed with which new packets arrive. In order to prevent emptying of the buffer, the presentation speed is decreased. The low-pass filter 351 is present to smooth the variations of the presentation speed. An alternative algorithm to determine the presentation rate fₚ out of the receive rate fᵣ is presented below. The receive rate fᵣ is defined by 1/(T_{receive}[k]−T_{receive}[k−1]) in which T_{receive}[k]−T_{receive}[k−1] is the difference between the arrival time of two subsequent packets. The presentation rate fₚ is defined by 1/(Tₚᵣₑₛₑₙₜₐₜᵢₒₙ[k]−Tₚᵣₑₛₑₙₜₐₜᵢₒₙ[k−1]) in which Tₚᵣₑₛₑₙₜₐₜᵢₒₙ[k]−Tₚᵣₑₛₑₙₜₐₜᵢₒₙ[k−1] is the difference between the presentation time of two subsequent packets.

In the following it is assumed that the arrival time difference value of two subsequent packets is never larger than the sum of the previous two arrival time difference values. This can be written as:

$$∀ i : \frac{1}{{f}_{r} [ i ]} < \frac{1}{{f}_{r} [ i - 1 ]} + \frac{1}{{f}_{r} [ i - 2 ]} \qquad ( 1 )$$

In the algorithm it is aimed to maintain 3 packets in the buffer. The algorithm operates as follows:

A. If at time T_{P}[i−2] there are three packets (packet i−2, packet i−1 and packet i) in the buffer, packet i−2 is taken from the buffer and presented at the rate with which the previous packet i−3 was received. This can be represented by f_{P}[i−2]=fᵣ[i−3]

B. At time T_{P}[i−1] the presentation of packet i−2 has been completed. For Tp[i−1] can be written:

$${T}_{P} [ i - 1 ] = {t}_{P} [ i - 2 ] + \frac{1}{{f}_{P} [ i - 2 ]} = {t}_{P} [ i - 2 ] + \frac{1}{{f}_{r} [ i - 3 ]} \qquad ( 2 )$$

Now two situations can be distinguished. If at Tp[i−1] packet i+1 has already arrived again three packets are in the buffer and the presentation rate to be used for the next packet i−1 is determined by A. When packet i+1 has not arrived yet and consequently fᵣ[i] is not known yet, the assumption (1) to bound the arrival T_{R} [i+1] of packet i+1 at latest at:

$${T}_{R} [ i - 1 ] = {T}_{R} [ i ] + \frac{1}{{f}_{R} [ i ]} \leq {T}_{P} [ i - 2 ] + \frac{1}{{f}_{R} [ i ]} < {T}_{P} [ i - 2 ] + \frac{1}{{f}_{r} [ i - 1 ]} + \frac{1}{{f}_{r} [ i - 2 ]} \qquad ( 3 )$$

In this case packet i−1 is taken from the buffer and presented at a rate of:

$$\frac{1}{{f}_{p} [ i - 1 ]} = \frac{1}{{f}_{r} [ i - 2 ]} + ( \frac{1}{{f}_{r} [ i - 1 ]} + \frac{1}{{f}_{r} [ i - 3 ]} ) \qquad ( 4 )$$

Packet i−1 is presented at the rate at which the previous packet was received extended with a stretch term.

C. At time Tp[i] the presentation of packet i−1 has been completed. T_{P}[i] is equal to:

$$\begin{matrix}\begin{matrix}{T}_{P} [ i ] = {T}_{P} [ i - 1 ] + \frac{1}{{f}_{p} [ i - 1 ]} \\ = ( {T}_{p} [ i - 2 ] + \frac{1}{{f}_{r} [ i - 3 ]} ) + ( \frac{1}{{f}_{r} [ i - 2 ]} + \frac{1}{{f}_{r} [ i - 1 ]} - \frac{1}{{f}_{r} [ i - 3 ]} ) \\ = {T}_{P} [ i - 2 ] + \frac{1}{{f}_{r} [ i - 2 ]} + \frac{1}{{f}_{r} [ i - 1 ]}\end{matrix} & ( 5 ) \\ & \end{matrix}$$

Packet i is still waiting in the buffer. According to (3) at least packet i+1 has also arrived at T_{P}[i]. Depending whether there are two or more packets are in the buffer, the presentation rate for the next packet is determined according to A (three packets or more) or B (two packets)

The algorithm ensures the buffer will never underflow, assuming (1) holds. It doesn't bound against buffer overflow. There are several alternative approaches conceivable.

Perform the rule for 3 packets in the buffer. Assuming that packets arrive at a constant rate in average, the buffer will stabilize, as fₚ is locking to fᵣ.

fₚ[i]=fᵣ[i], i.e. ΔT BUF=constant. The buffer will empty when the reception rate decreases; otherwise it will stay constant.

fₚ[i]=max {fₚ[i−1] fᵣ[i] fᵣ[i+1], . . . }

fₚ[i] is the average of all fᵣ of all packet in the buffer which stabilizes the output rate at constant birate.

Use a shrink term to increase the presentation rate when the number of packets in the buffer increases.

The input signal sₛ[n] of the speech encoder 1 according to FIG. 4, is filtered by a DC notch filter 210 to eliminate undesired DC offsets from the input. Said DC notch filter has a cut-off frequency (−3 dB) of 15 Hz. The output signal of the DC notch filter 210 is applied to an input of a buffer 211. The buffer 211 presents blocks of 400 DC filtered speech samples to a voiced speech encoder 216 according to the invention. Said block of 400 samples comprises 5 frames of 10 ms of speech (each 80 samples). It comprises the frame presently to be encoded, two preceding and two subsequent frames. The buffer 211 presents in each frame interval the most recently received frame of 80 samples to an input of a 200 Hz high pass filter 212. The output of the high pass filter 212 is connected to an input of a unvoiced speech encoder 214 and to an input of a voiced/unvoiced detector 228. The high pass filter 212 provides blocks of 360 samples to the voiced/unvoiced detector 228 and blocks of 160 samples (if the speech encoder 4 operates in a 5.2 kbit/sec mode) or 240 samples (if the speech encoder 4 operates in a 3.2 kbit/sec mode) to the unvoiced speech encoder 214. The relation between the different blocks of samples presented above and the output of the buffer 211 is presented in the table below.

| | 5.2 kbit/sec | | 3.2 kbit/s | |
|---|---|---|---|---|
| Element | # samples | Start | #samples | Start |
| High pass filter 212 | 80 | 320 | 80 | 320 |
| Voiced/unvoiced | 360 | 0 . . . 40 | 360 | 0 . . . 40 |
| detector 228 | | | | |
| Voiced speech | 400 | 0 | 400 | 0 |
| encoder 216 | | | | |
| Unvoiced speech | 160 | 120 | 240 | 120 |
| encoder 214 | | | | |
| Present frame to | 80 | 160 | 80 | 160 |
| be encoded | | | | |

The voiced/unvoiced detector 228 determines whether the current frame comprises voiced or unvoiced speech, and presents the result as a voiced/unvoiced flag. This flag is passed to a multiplexer 222, to the unvoiced speech encoder 214 and the voiced speech encoder 216. Dependent on the value of the voiced/unvoiced flag, the voiced speech encoder 216 or the unvoiced speech encoder 214 is activated.

In the voiced speech encoder 216 the input signal is represented as a plurality of harmonically related sinusoidal signals. The output of the voiced speech encoder provides a pitch value, a gain value and a representation of 216 prediction parameters. The pitch value and the gain value are applied to corresponding inputs of a multiplexer 222.

In the 5.2 kbit/sec mode the LPC computation is performed every 10 ms. In the 3.2 kbit/sec the LPC computation is performed every 20 ms, except when a transition between unvoiced to voiced speech or vice versa takes place. If such a transition occurs, in the 3.2 kbit/sec mode the LPC calculation is also performed every 10 msec.

The LPC coefficients at the output of the voiced speech encoder are passes to a corresponding input of a multiplexer 222

In the unvoiced speech encoder 14 a gain value and 6 prediction coefficients are determined to represent the unvoiced speech signal. The gain value and the 6 LPC coefficients are passed to corresponding inputs of the multiplexer 222. The multiplexer 222 is arranged for selecting the encoded voiced speech signal or the encoded unvoiced speech signal, dependent on the decision of the voiced-unvoiced detector 228. At the output of the multiplexer 222 the encoded speech signal is available.

In the speech decoder 216 according to FIG. 5, the encoded LPC codes and a voiced/unvoiced flag are passed to a demultiplexer 92. The gain value and the received refined pitch value are also passed to the demultiplexer 92.

If the voiced/unvoiced flag indicates a voiced speech frame, the demultiplexer 92 passes the refined pitch, the gain and the 16 LPC codes to a harmonic speech synthesizer 94. If the voiced/unvoiced flag indicates an unvoiced speech frame, demultiplexer 92 passes the gain and the 6 LPC codes to an unvoiced speech synthesizer 96. The synthesized voiced speech signal ŝ_{v,k}[n] at the output of the harmonic speech synthesizer 94 and the synthesized unvoiced speech signal ŝ_{uv,k}[n] at the output of the unvoiced speech synthesizer 96 are applied to corresponding inputs of a multiplexer 98.

In the voiced mode, the multiplexer 98 passes the output signal ŝ_{v,k}[n] of the Harmonic Speech Synthesizer 94 to the input of the Overlap and Add Synthesis block 100. In the unvoiced mode, the multiplexer 98 passes the output signal ŝ_{uv,k}[n] of the Unvoiced Speech Synthesizer 96 to the input of the Overlap and Add Synthesis block 100. In the Overlap and Add Synthesis block 100, partly overlapping voiced and unvoiced speech segments are added. For the output signal ŝ[n] of the Overlap and Add Synthesis Block 100 can be written:

$$\hat{s} [ n ] = \{ \begin{matrix}\begin{matrix}\begin{matrix}{\hat{s}}_{uv , k - 1} [ n + {N}_{s} / 2 ] + {\hat{s}}_{uv , k} [ n ] ; {v}_{k - 1} = 0 , {v}_{k} = 0 \\ {\hat{s}}_{uv , k - 1} [ n + {N}_{s} / 2 ] + {\hat{s}}_{v , k} [ n ] ; {v}_{k - 1} = 0 , {v}_{k} = 1\end{matrix} \\ {\hat{s}}_{v , k - 1} [ n + {N}_{s} / 2 ] + {\hat{s}}_{uv , k} [ n ] ; {v}_{k - 1} = 1 , {v}_{k} = 0\end{matrix} \\ {\hat{s}}_{v , k - 1} [ n + {N}_{s} / 2 ] + {\hat{s}}_{v , k} [ n ] ; {v}_{k - 1} = 1 , {v}_{k} = 1\end{matrix} \\ for 0 < n < {N}_{s} \qquad ( 6 )$$

In (6) Ns is the length of the speech frame, vₖ₋₁ is the voiced/unvoiced flag for the previous speech frame, and vₖ is the voiced/unvoiced flag for the current speech frame. It is observed that the length Ns can change according to the desired presentation speed. If the length of frame k−1 is equal to Nₖ₋₁, (6) changes into:

$$\hat{s} [ n ] = \{ \begin{matrix}\begin{matrix}\begin{matrix}{\hat{s}}_{uv , k - 1} [ n + {N}_{k - 1} / 2 ] + {\hat{s}}_{uv , k} [ n ] ; {v}_{k - 1} = 0 , {v}_{k} = 0 \\ {\hat{s}}_{uv , k - 1} [ n + {N}_{k - 1} / 2 ] + {\hat{s}}_{v , k} [ n ] ; {v}_{k - 1} = 0 , {v}_{k} = 1\end{matrix} \\ {\hat{s}}_{v , k - 1} [ n + {N}_{k - 1} / 2 ] + {\hat{s}}_{uv , k} [ n ] ; {v}_{k - 1} = 1 , {v}_{k} = 0\end{matrix} \\ {\hat{s}}_{v , k - 1} [ n + {N}_{k - 1} / 2 ] + {\hat{s}}_{v , k} [ n ] ; {v}_{k - 1} = 1 , {v}_{k} = 1\end{matrix} \\ for 0 < n < {N}_{s} \qquad ( 7 )$$

The output signal ŝ[n] of the Overlap and Add Synthesis Block 100 is applied to a postfilter 102. The postfilter is arranged for enhancing the perceived speech quality by suppressing noise outside the formant regions.

In the voiced speech decoder 94 according to FIG. 6, the encoded pitch received from the demultiplexer 92 is decoded and converted into a pitch frequency by a pitch decoder 104. The pitch frequency determined by the pitch decoder 104 is applied to an input of a phase synthesizer 106, to an input of a Harmonic Oscillator Bank 108 and to a first input of a LPC Spectrum Envelope Sampler 110.

The LPC coefficients received from the demultiplexer 92 is decoded by the LPC decoder 112. The way of decoding the LPC coefficients depends on whether the current speech frame contains voiced or unvoiced speech. Therefore the voiced/unvoiced flag is applied to a second input of the LPC decoder 112. The LPC decoder passes the reconstructed a-parameters to a second input of the LPC Spectrum envelope sampler 110. The operation of the LPC Spectral Envelope Sampler 112 is described by (13), (14) and (15) because the same operation is performed in the Refined Pitch Computer 32.

The phase synthesizer 106 is arranged to calculate the phase φₖ[i]of the i^{th} sinusoidal signal of the L signals representing the speech signal. The phase φₖ[i] is chosen such that the i^{th} sinusoidal signal remains continuous from one frame to a next frame. The voiced speech signal is synthesized by combining overlapping frames, each comprising Ns windowed samples. There is a 50% overlap between two adjacent frames as can be seen from graph 219 and graph 223 in FIG. 7. In graphs 219 and 223 the used window is shown in dashed lines. The phase synthesizer is now arranged to provide a continuous phase at the position where the overlap has its largest impact. With the window function used here this position is at sample 119. For the phase φₖ[i] of the current frame can now be written:

$${ϕ}_{k} [ i ] = {ϕ}_{k - 1} [ i ] + i \cdot {ω}_{0 , k - 1} \frac{3 {N}_{s}}{4} - i \cdot {ω}_{0 , k} \frac{{N}_{s}}{4} ; 1 \leq i \leq 100 \qquad ( 8 )$$

In the currently described speech encoder the value of Nₛ is equal to 160. For the very first voiced speech frame, the value of φₖ[i] is initialized to a predetermined value.

The harmonic oscillator bank 108 generates the plurality of harmonically related signals ŝ′_{v,k}[n] that represents the speech signal. This calculation is performed using the harmonic amplitudes \hat{m}[i], the frequency \hat{f}₀ and the synthesized phases \hat{φ} [i] according to:

$${\hat{s}}_{v , k}^{′} [ n ] = {\sum }_{i = 1}^{L} \hat{m} [ i ] cos \{ ( i \cdot 2 π \cdot {f}_{0} ) \cdot n + \hat{ϕ} [ i ] \} ; 0 \leq n < {N}_{s} \qquad ( 9 )$$

The signal ŝ′_{v,k}[n] is windowed using a Hanning window in the Time Domain Windowing block 114. This windowed signal is shown in graph 221 of FIG. 7. The signal ŝ′_{v,k}+[n] is windowed using a Hanning window being Nₛ/2 samples shifted in time. This windowed signal is shown in graph 225 of FIG. 7. The output signals of the Time Domain Windowing Block 114 is obtained by adding the above mentioned windowed signals. This output signal is shown in graph 227 of FIG. 7. A gain decoder 118 derives a gain value gᵥ from its input signal, and the output signal of the Time Domain Windowing Block 114 is scaled by said gain factor gᵥ by the Signal Scaling Block 116 in order to obtain the reconstructed voiced speech signal ŝ_{v,k}.

If according to the inventive concept of the present invention, the presentation speed of the multimedia is changed, several changes have to be made to the synthesis process described above. In the following it is assumed that the frame length indicator is represented by a number of samples Nᵢ in which i is the number of the frame. First the phases φₖ[i] have to be determined from the number of samples Nᵢ₋₁ and Nᵢ₋₂ of the frames preceeding the current frame to be synthesized. These phases are calculated according to:

$${ϕ}_{k} [ i ] = {ϕ}_{k - 1} [ i ] + i \cdot 2 π \cdot {f}_{0 , k - 1} ( \frac{{N}_{k - 2}}{2} + \frac{{N}_{k - 1}}{4} ) - i \cdot 2 π \cdot {f}_{0 , k} \frac{{N}_{k - 1}}{4} ; 1 \leq i \leq 100 \qquad ( 10 )$$

Subsequently the signal ŝ_{v,k} is synthesized according to:

$${\hat{s}}_{v , k}^{′} [ n ] = {\sum }_{i = 1}^{L} \hat{m} [ i ] cos \{ ( i \cdot 2 π \cdot {f}_{0} ) \cdot n + \hat{ϕ} [ i ] \} ; 0 \leq n < {N}_{i} \qquad ( 11 )$$

The operation of the time domain windowing block 114 is also slightly changed when the number of samples in a frame differs from the nominal value Nₛ. The length of the Hanning window used to window the signal ŝ_{v,k}[n] is equal to Nₖ instead of Nₛ.

In FIG. 8 the same signals as in FIG. 7 are shown, but now the presentation speed is changed at the boundary of two segments. The segment represented by graph 418 is substantially shorter than the segment represented by graph 422. After windowing and adding the windowed signals according to graphs 420 and 424 the signal according to graph 426 is obtained.

In the unvoiced speech synthesizer 96 according to FIG. 9, the LPC codes and the voiced/unvoiced flag are applied to an LPC Decoder 130. The LPC decoder 130 provides a plurality of 6 a-parameters to an LPC Synthesis filter 134. An output of a Gaussian White-Noise Generator 132 is connected to an input of the LPC synthesis filter 143. The output signal of the LPC synthesis filter 134 is windowed by a Hanning window in the Time Domain Windowing Block 140.

An Unvoiced Gain Decoder 136 derives a gain value ĝuv representing the desired energy of the present unvoiced frame. From this gain and the energy of the windowed signal, a scaling factor ĝ′ᵤᵥ for the windowed speech signal gain is determined in order to obtain a speech signal with the correct energy. For this scaling factor can be written:

$${\hat{g}}_{uv}^{′} = \sqrt{\frac{{\hat{g}}_{uv}}{\frac{1}{{N}_{s}} {\sum }_{n = 0}^{{N}_{s} - 1} {( {\hat{s}}_{uv , k}^{′} [ n ] \cdot w [ n ] )}^{2}}} \qquad ( 12 )$$

The Signal Scaling Block 142 determines the output signal ŝ_{uv,k} by multiplying the output signal of the time domain window block 140 by the scaling factor ĝ′ᵤᵥ.

The presently described speech encoding system can be modified to require a lower bitrate or a higher speech quality. An example of a speech encoding system requiring a lower bitrate is a 2 kbit/sec encoding system. Such a system can be obtained by reducing the number of prediction coefficients used for voiced speech from 16 to 12, and by using differential encoding of the prediction coefficients, the gain and the refined pitch. Differential coding means that the date to be encoded is not encoded individually, but that only the difference between corresponding data from subsequent frames is transmitted. At a transition from voiced to unvoiced speech or vice versa, in the first new frame all coefficients are encoded individually in order to provide a starting value for the decoding.

It is also possible to obtain a speech coder with an increased speech quality at a bit rate of 6 kbit/s. The modifications are here the determination of the phase of the first 8 harmonics of the plurality of harmonically related sinusoidal signals. The phase φ[i] is calculated according to:

$$ϕ [ i ] = arctan \frac{I ( {θ}_{i} )}{R ( {θ}_{i} )} \qquad ( 13 )$$

Herein is θᵢ=2πf₀·i. R(θᵢ) en I(θᵢ) are equal to:

$$\begin{matrix}R ( {θ}_{i} ) = {\sum }_{n = 0}^{N - 1} {s}_{W} [ n ] \cdot cos ( {θ}_{i} \cdot n ) & ( 14 ) \\ and & \\ I ( {θ}_{i} ) = - {\sum }_{n = 0}^{N - 1} {s}_{W} [ n ] \cdot sin ( {θ}_{i} \cdot n ) & ( 15 )\end{matrix}$$

The 8 phases φ[i] obtained so are uniformly quantised to 6 bits and included in the output bitstream.

A further modification in the 6 kbit/sec encoder is the transmission of additional gain values in the unvoiced mode. Normally every 2 msec a gain is transmitted instead of once per frame. In the first frame directly after a transition, 10 gain values are transmitted, 5 of them representing the current unvoiced frame, and 5 of them representing the previous voiced frame that is processed by the unvoiced speech encoder. The gains are determined from 4 msec overlapping windows.

In the video decoder 16 according to FIG. 10, the first input carrying the video signal consisting of a plurality of video frames is coupled to a first input of an interpolator 304 and to an input of a frame memory 302. The frame memory 302 is arranged for storing the video frame previously received from the buffer 10. The output of the frame memory 302 is connected to a second input of the interpolator 304.

The interpolator 304 is arranged for interpolating the previous video frame and the current video frame received from the buffer 10. The interpolator provides to its output a video signal with a constant frame rate for use by the presentation device 18.

According to the inventive concept of the present invention, the presentation speed depends on a delay measure. In this case, it means that the video frames received from the buffer 10 are not always displayed at the same interval. The interval between two frames is dependent on the delay measure.

In order to be able to present a video signal with a substantially constant frame rate to the presentation device, the interpolator 304 determines a number of interpolated frames which depends on the interval between the video frames received from the buffer 10.

Calculation means 306 calculate the number frames to be interpolated, from the presentation speed provided by the clock generator 24 in FIG. 2. In case time stamps are used in the video signal, a difference Δ between the time stamps of the present and the previous frame is provided to the calculation means 306. This enables the calculation means 306 also to determine the correct number of frames to be interpolated when one or more of the video frames is lost.

A suitable interpolator 304 is described by G. de Haan in the article “Judder free video on PC's” at the Winhec 98 conference held in Orlando in March 1998.

1. Arrangement for reproducing a multimedia signal comprises presenting means for presenting the multimedia signal to a user, characterized in that the arrangement station comprises delay determining means for determining a delay measure representing the arrival delay of packets carrying the multimedia signal, and in that the presenting means are arranged for varying the presentation speed in dependence on said delay measure.

2. Arrangement according to claim 1, characterized in that the multimedia signal comprises an audio signal, and in that the presenting means are arranged for varying the presenting speed of the audio signal without substantially changing a perceived intonation of the audio signal.

3. Arrangement according to claim 2, characterized in that the audio signal is represented by a plurality of segments comprising a plurality of signals being described by at least their amplitude and frequency, and in that the presenting means are arranged for changing the duration of said segments in dependence on said delay measure.

4. Arrangement according to claim 1, characterized in that the presentation means comprise control means having comparison means for determining a difference signal representing a difference between the delay measure and a reference value, and in that the presentation means comprises adjusting means for adjusting the presenting speed in dependence on the difference value.

5. Arrangement according to claim 4, characterized in that the presentation means comprises adaptation means for adapting the reference value in dependence on the variations of the difference value.

6. Arrangement according to claim 1, characterized in that the multimedia signal comprises a video signal.

7. Arrangement according to claim 6, characterized in that the video signal is represented by a at least one object, and in that the presentation means are arranged for varying the presentation speed by adjusting a movement speed of at least one object in the video signal.

8. Arrangement according to claim 1, characterized in that the multimedia signal comprises at least two components, in that the delay measure represents a timing difference between said at least two components, and in that the presentation means are arranged for varying the presentation speed in order to reduce said timing difference.

9. Method for reproducing a multimedia signal, said method comprises presenting the multimedia signal to a user, characterized in that the method further comprises determining a delay measure representing an arrival delay of packets carrying the multimedia signal, and in that the method comprises changing the presentation speed in dependence on said delay measure.

10. Method according to claim 9, characterized in that the multimedia signal comprises an audio signal, and in that the method comprises varying the presenting speed of the audio signal without substantially changing a perceived intonation of the audio signal.

11. Method according to claim 210, characterized in that the audio signal is represented by a plurality of segments comprising a plurality of waveforms being described by at least their amplitude and frequency, and in that the method comprises changing the duration of said segments in dependence on said delay measure.

12. Method according to claim 9, characterized in that the multimedia signal comprises a video signal.

13. Method according to claim 212, characterized in that the video signal is represented by a at least one object, and in that the method comprises varying the presentation speed by adjusting a movement speed of at least one object in the video signal.
